(19) United States
(12) Patent Application Publication
(10) Pub. No.: US 2009/0304181 A1
(43) Pub. Date: Dec. 10, 2009

(54) Method for generating and/or imprinting a retrievable cryptographic key during the production of a topographic structure

(76) Inventors: Peter Fischer, Ketsch (DE); Matthias Harter, Frankfurt (DE)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/921,058

(22) PCT Filed: May 26, 2006
(86) PCT No.: PCT/DE2006/000909

§ 371 Date: Aug. 10, 2009

(30) Foreign Application Priority Data
May 27, 2005 (DE) 10 2005 024 379.7

(51) Int. Cl. H04L 9/06; G01R 27/26

(52) U.S. Cl. 380/46; 324/686

(57) ABSTRACT

The present invention relates to a method for generating and imprinting a retrievable cryptographic key during the fabrication of a topographic structure, in particular for microelectronic or micromechanical components.

In the method a multiplicity of measuring circuits (11) is generated in the topographic structure, which measuring circuits each dependent on a value of at least one electrical or physical property in the topographic structure, which is subject to random fluctuations during the fabrication of the topographic structure containing the measuring circuits (11), generate a measuring value.

The cryptographic key is formed or derived from the measuring values of the measuring circuits (11). The measuring circuits (11) are composed of three-dimensional electrical line structures (9, 10), each of which is provided with a random design and is generated in the topographic structure, and generate the measuring values dependent on the value of a parasitic electrical property of the line structures (9, 10).

### BACKGROUND OF THE INVENTION

The present invention relates to a method for generating and/or imprinting a retrievable cryptographic key during the production of a topographic structure, in particular for microelectronic or micromechanical components, such as a chip or a chip card, in which such a type cryptographic key is imprinted.

Secret keys which in some application cases should be integrated in a physical medium, for example a chip or chip card, are required in cryptographic applications. An adversary should not be able to calculate such type secret keys or only with great difficulty or gain access to them using so-called reverse engineering methods.

### PRIOR ART

In classical methods, the secret key is generated by a random generator and stored in one part of the physical medium, for example on a hard disk or in an EEPROM. Copies of the secret key stored in this manner can however be reconstructed with relative ease by means of reverse engineering analysis.

In practice, often employed for generating the secret key are random generators, which for their part require a random start value. This start value can be generated from interaction with the user, for example by means of random input by the user using an input device in the computer system. Furthermore, methods are known in which the radioactive decomposition of an isotope is utilized to generate a start value for the random generator from it. Such type devices are, however, usually large and expensive.

EP 1 465 254 A1 describes a method for storing an identification number in a semiconductor chip in which bit-generating circuits are integrated in the topographic structure of the semiconductor chip. Each bit-generating circuit generates a certain bit of the identification number. Each of the bit-generating circuits is composed of an electrical line extending over a multiplicity of planes of the topographic structure. The bit values are determined by the presence or absence of interruptions in the electrical line, which occurs by provision of a suited layout when generating the topographic structure containing the bit-generating circuits. Use of this method for imprinting a secret key for cryptographic applications has, however, the drawback that it is relatively easy to extract the imprinted information using the bit-generating circuits by analysis.

U.S. Pat. No. 6,047,068 A describes a method for determining a cryptographic key which is allocated to an integrated circuit in which randomly fluctuating material properties are employed to generate the key. According to the method of this printed publication, for this purpose, an additional special layer, which has a randomly locally varying electrical resistance, has to be applied on an electrical contact grid. The cryptographic key can then be derived from measuring the resistance between the different combinations of electrical contacts.

US 2002/0188857 A1 discloses a method for protecting at least one data value in an integrated circuit, in which this data value is combined with a second data value yielded by a network of physical parameters of the integrated circuit. Only the result of the combination is subsequently stored in the memory of the integrated circuit. The second data value is determined by the network of physical parameters, which are subject to random variations during fabrication of the integrated circuit.

US 2003/0103629 A1 describes a method for generating a secret data value, respectively a key, in an integrated circuit. The aim is for third parties to be able to determine the data value only with great difficulty. Like US 2002/0188857 A1, this method utilizes a network of physical parameters of the IC for storing the data value.

WO 01/84767 describes a method for generating cryptographic keys, in which the charge levels of the memory cells of an EEPROM are used to generate a key.

US 2004/0136529 A1 deals with an electronic component which generates its cryptographic key itself. Generation occurs using measurement means which measure the component's physical parameters, which vary randomly during fabrication. In one example, inverters are employed to measure these parameters.

U.S. Pat. No. 5,818,738 A deals with a method of verifying the authenticity of an integrated circuit using fabrication-inherent randomly varying physical parameters.

U.S. Pat. No. 6,233,339 B1 deals with cryptography based on physical properties. The material properties of a material, respectively the properties of a liquid, contained in a sealed volume in an IC, are employed for generating the cryptographic key.

The object of the present invention is to provide a method for imprinting a retrievable cryptographic key in a physical medium. The method should make it very difficult for third parties to extract the secret key from the physical medium. Furthermore, provided should be a physical medium in the form of a chip or a chip card containing a secret key that is very difficult to extract.

### DESCRIPTION OF THE INVENTION

The object is solved using the method according to the claims 1 and 4 as well as the physical medium according to claim 10. Advantageous embodiments of the method are the subject matter of the subordinate claims or can be drawn from the the following description and the embodiments.

The two variants of the method proposed according to the present invention differ in that according to the method of claim 1, the secret key is randomly generated during generation of the topographic structure, whereas in the method according to claim 4 this key is predetermined before generation of the topographic structure. With the first variant, physical media can be provided with a topographic structure of which each automatically bears an individual secret key. On the other hand, the method of claim 4 is suited to provide a multiplicity of physical media with the same secret key.

In the method according to claim 1, for generating and imprinting the retrievable cryptographic key, a multiplicity of measuring circuits are generated in the topographic structure during production thereof. The measuring circuits generate a measuring value dependent on a value of at least one electrical or physical property in the topographic structure. The electrical or physical property whose value is significant for generating the measuring value is a property whose value is subject to random fluctuations during fabrication of the topographic structure containing the measuring circuits. The cryptographic key is finally formed or derived from the measuring values of the measuring circuits. The measuring values are bits of a bit sequence. However, keys can also be generated in a different number system.

This method utilizes that a physical production process for fabricating a topographic structure, for example a lithographic process in the semiconductor industry, is a natural random generator. The random value is yielded from the physical properties of the produced product which are subject to statistical fluctuations from product to product and therefore is random. The random value is therefore difficult to access, measure or simulate from outside the product. On the other hand, due to the stability of the physical properties in the finished product, the random value is firmly imprinted and is retrievable at any time. This is utilized in the method according to claim 1, in which physical or electrical properties in the topographic structure which are subject to fluctuations from product to product in the selected production process are selectively used to generate the cryptographic key via suitably introduced measuring circuits. Due to the stability of the selected properties of the topographic structure, this cryptographic key is sustained and can therefore be reproduced at any time via the measuring circuits and read out. Selected are parasitic electrical properties in the topographic structure which are independent of the operation parameters, for example amplification voltage, temperature, etc.

The measuring circuits are generated in such a manner that they comprise complex three-dimensional electrical line structures in the topographic structure whose parasitic properties are used in the measuring circuit for generating the measuring value. For generating and imprinting a bit sequence, a separate measuring circuit can be generated in the topographic structure for each bit of the bit sequence of the cryptographic key. However, this is not necessary in every instance as is explained with reference to the exemplary measuring circuit of FIG. 11. The respective bit can, for example, then be obtained by comparing the value of one electrical or physical property measured with the measuring circuit and a predetermined value.

In this manner the stable parasitic properties of the topographic structure, in particular of a semiconductor topography, are converted via the measuring circuits into a bit pattern which yields the secret key. Used as parasitic electrical properties can be, for example the capacitances between lines, parasitic inductances or also a cross-over between lines. These properties are subject to fluctuations from topography to topography, but considered separately are constant and independent of operation parameters. From the statistical fluctuations of these properties and the difficulty of determining these ex posteriori with the required accuracy also when using auxiliary tools of electronic design automation, the desired uncertainty relating to the bit pattern is achieved.

On the chip, the electrical lines made of aluminum or copper are suited line structures. Although these line structures are usually employed to exchange signals, respectively information, between functional units such as individual transistors or logic gates, they can however also be used to realize passive components such as coils or capacitors. Usually, well-defined rules in the geometric design of the metal structures are followed so that the electrical capacitance, respectively the inductance, is controlled as exactly as possible.

However the complex line structures, hereinafter also referred to as capacitance clusters, serve a completely different purpose for the parasitic capacitances of the present measuring circuits. Although here too the electrical capacitances are utilized in the circuit, their exact value should be as difficult as possible for an outsider to determine. In this manner, the behavior of the measuring circuit should be rendered extremely unpredictable and ultimately inaccessible.

In this manner, as in the following described alternative method for imprinting a secret key, the complex three-dimensional line structure is obtained by provision of a random three-dimensional design of the line structure employed for generating the line structure in the topographic structure. This generation of a random, complex three-dimensional line structure makes it more difficult for an adversary to calculate the respective parasitic electrical property. On the other hand, due to the previously generated random design, which is known only to the user, this property can be precisely calculated by the user of the method.

Generation of the design occurs using an algorithm which randomly selects the layout of the line structures, for example width, length and orientation of the sections of the line structures in each level of the line structures as well as the connections between different planes of the line structures.

In an especially advantageous embodiment of the present method, two such obtained line structures are generated for every measuring circuit and the values of the parasitic property of theses two line structures are compared by a comparison circuit. Dependent on the result of this comparison, the measuring circuit then generates a bit value of 0 or 1. This bit value can depend on which of the two values of the parasitic property of the two line structures is larger or smaller or whether the two are the same within a predetermined range. In the method according to claim 1, the identical, randomly obtained design is used for the two line structures of each measuring circuit. Different measuring circuits however have different designs. Due to the fabrication process, the parasitic electrical properties of the two line structures of each measuring circuit however fluctuate despite the identical design so that the desired random bit value is yielded for different measuring circuits.

On the other hand, in the method according to claim 4, the two line structures of each measuring circuit are selected so differently that the desired predetermined bit value is yielded in each case despite of the fluctuations during the production process. Due to the possibility of precalculation of the value of the parasitic properties of the line structures, this varying selection can occur from the designs randomly generated to start with. On the other hand, an adversary can derive information about the secret key from the complex line structures only with great difficulty.

The two alternative methods utilize electrical or physical properties of the topographic structure, which are subject to fluctuations during production, to imprint the secret key. Both methods employ complex line structures of the measuring circuits resulting from the random designs of the line structures. In the first method, the fluctuations in the fabrication process are used to generate the secret key. In the second method, the knowledge of these fluctuations is used to set the predetermined bit values for the individual measuring circuits.

### BRIEF DESCRIPTION OF THE DRAWINGS

The present method is made more apparent in the following using an embodiment with reference to the accompanying drawings without the intention of limiting the scope or spirit of the protection range set forth in the claims.

FIG. 1 shows an example of the buildup of a measuring circuit as it can be employed in the present method;

FIG. 2 shows an exemplary schematic representation of a complex line structure according to the present method;

FIG. 3 shows an example of the first part of an algorithm for creating a random design of a line structure according to the present method;

FIG. 4 shows an example of the second part of an algorithm for creating a random design of a line structure according to the present method;

FIG. 5 shows an example of a layout view of a line structure according to the present method according to which the line structure is created in the topography;

FIG. 6 shows a 3D visualization of a line structure according to the layout view of FIG. 5;

FIG. 7 shows a first application example in an electronic key for a passenger car;

FIG. 8 shows a second application example for transmission and distribution of multi-media contents;

FIG. 9 shows a third application example for the protection of software;

FIG. 10 shows a fourth application example for the protection of software;

FIG. 11 shows a further example of the buildup of a measuring circuit as it can be used in the present method;

FIG. 12 shows in detail a part of the measuring circuit of FIG. 11.

### WAYS TO CARRY OUT THE INVENTION

In the present embodiment, the invented method is employed in the production of the topography of a semiconductor chip. The measuring circuits are executed as microelectronic circuits on the chip, the parasitic capacitances between certain regions of the topography of the chip are converted into a bit pattern from which the private key is derived.

The measuring circuit 11 of FIG. 1 is laid out in the present example in such a manner that this bit pattern reacts very sensitively to the fluctuations of the capacitances. The negligible difference in the capacitance of the measuring circuits between two random chips should generate another bit pattern. This is the case due to the inevitable statistical process fluctuations in the fabrication of the chip and is utilized in the present method.

However, if, according to the second variant of the present method, always the same keys should be generated for all the chips, the capacitances of the measuring circuit are dimensioned in such a manner that the circuit does not react to the process fluctuations. Key retrievability, respectively key readoutability, at any time is yielded by the stability of the individual capacitances via use time and independence of these capacitances of the supply voltage, temperature, age and stress.

In the present example, conversion of the parasitic capacitances into a bit pattern occurs by means of a circuit principle, as shown in FIG. 1. In this case two capacitances 5, 6 are generated in the semiconductor topography. The production of capacitances will be dealt with in more detail in the following. The two capacitances 5, 6 are charged successively via a constant current I from a current source 1 for a certain time T. The electrical voltage V via the capacitances 5, 6 is dependent on the charge current I, the charge time T and the capacitance C: V=I*T*1/C. As the current and the charge time are constant, the voltage is proportional to the inverse value of the capacitance: V˜1/C. The difference between the obtained voltage values is formed via a comparator and is converted into a digital 0/1 result at the output 8. The switches 2 to 4 ensure via a suited switch sequence that the two capacitances are charged and that the voltage then remains constant. For this purpose, for example, switch 2 can be opened and switch 3 can be closed for the duration of the charge procedure of capacitance 5. By closing switch 4, the other capacitance 6 is charged as well. If switches 3, 4 are reopened, the voltage via the capacitances 5, 6 remains constant. At this time, the result of the comparison of the comparator 7 is valid. It indicates whether the capacitance 5 is larger or smaller than the capacitance 6. By closing switch 2, the capacitances can be discharged again. The entire measuring circuit 11 is created in the course of creating the semiconductor topography by means of a suited layout in the lithographic fabrication of this topography. For a cryptographic key of n bit, n of these measuring circuits 11 are generated in the semiconductor topography.

In the present example, the layouts of the two parasitic capacitances 5, 6 are selected as complex as possible in order to make prediction of the imprinted key more difficult for the adversary. Furthermore, for this purpose the layout of the parasitic capacitances 5, 6 are always selected for two random bits each, respectively two measuring circuits each already when designing in such a manner that their three-dimensional structure differs as greatly a possible.

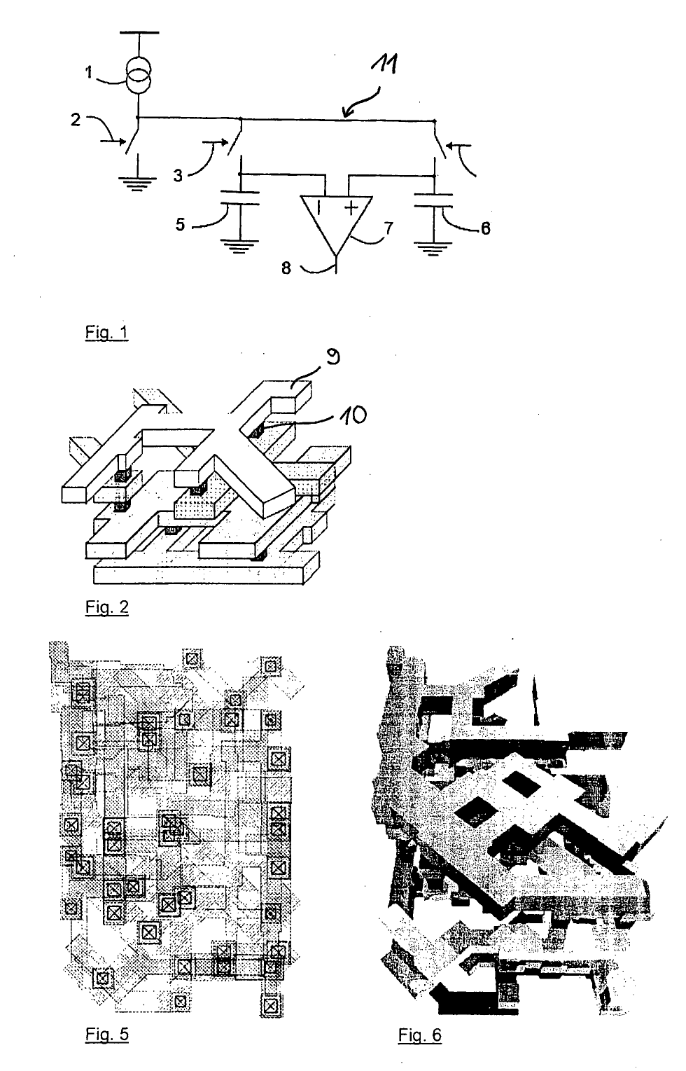

FIG. 2 schematically shows an example of such a type parasitic capacitance composed of a complex three-dimensional line structure, with the individual lines 9 of the line structure branching out frequently, extending in different directions even over different planes of the topographic structure via corresponding through contactings 10. The example in FIG. 2 clearly shows the irregularity of this line structure with regard to width, length and orientation of the individual line sections, which are randomly selected during designing.

Fundamentally, selection of the design, respectively the layout of the two capacitances 5, 6 depends on whether an individual key should be generated for each single chip, referred hereinafter to as single-chip key, or whether all the chips should have the same key, hereinafter referred to as all-chips key. In the first instance, the same layout is selected for the capacitances 5, 6 in a measuring circuit in such a manner that their three-dimensional structure is identical apart from fluctuations. For the above reasons, these structures, however, still possess a random, irregular buildup in which the lengths and widths of the lines vary greatly.

In the second instance, the different designs, respectively layouts, of the capacitances 5, 6 of a measuring circuit are selected in such a manner that their three-dimensional buildup differs greatly within the measuring circuit. Furthermore, it is advantageous if the three-dimensional buildup of the capacitances 5,6 of different measuring circuits also differs greatly. In this case, the line structures of the capacitances 5, 6 are selected in such a manner that their electrical capacitances differ more than they vary from chip to chip due to process-based fluctuations.

In both cases, the three-dimensional layout of the line structures for the parasitic capacitances is generated with a random generator. As two such type structures are needed for each bit, it is necessary to prepare during the designing period a great number of layouts, whose electrical capacitance is known. The capacitance can be calculated from the layout.

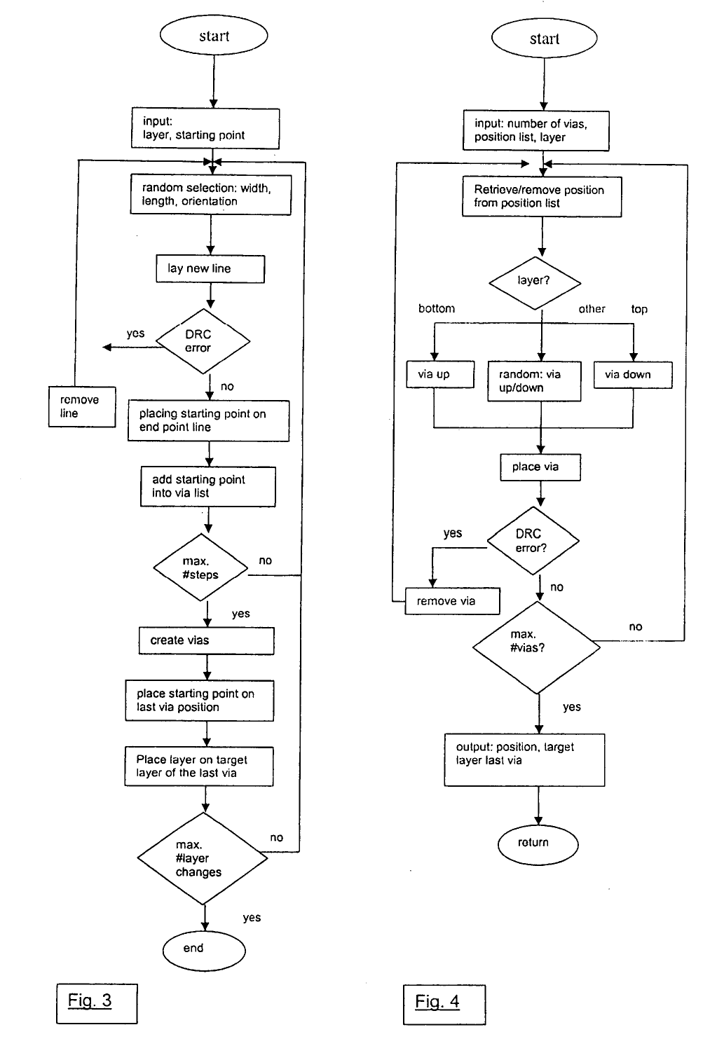

FIG. 3 shows an example of the generation of layouts of line structures with a random three-dimensional design. All the steps are automated and are fully executed by a computer in such a manner that after a running time of a few hours a large number of layouts, which can be used for fabricating the topographic structure, are at disposal. The algorithm shown as an example in FIG. 3 is based on an iterative random process, hereinafter referred to as random-walk algorithm. Its purpose is to generate three-dimensional connecting structures within a predetermined area. These structures should have an inaccurate as possible known or very difficult calculatable electrical capacitance.

For this purpose, the design rules for capacitors are intentionally violated so that the capacitance clusters are no longer “conventional” capacitors. No metal plates are used but rather a multiplicity of more or less thin metal lines combined to form a complex, irregular, random structure as already described in context with FIG. 2. Regarding the circuit, the electrical capacitance is usually undesired or even disadvantageous. For this reason, it is referred to as the parasitic capacitance. This parasitic capacitance of the metal lines should be correspondingly optimized for the used purpose inside the capacitance cluster and rendered usable with regard to the circuit. As a large number of capacitance clusters is required, designing should be automated. Random-walk algorithms have been developed for this and translated into the script language SKILL permitting use of electronic design automation (EDA) tools in circuit fabrication.

An important criteria for the use of parasitic clusters is the ability to completely automate the designing process. Creating the buildup, respectively the design (mask layout) of each single cluster should be possible without repeated user action or manual control. The only form of user interaction is setting certain start parameters or adjustments that can only be carried out at the start of the automatic designing procedure. The reason for this requirement lies in the great number of clusters needed for a private key with a realistic number of bits: for cryptographic processes with public keys usually 1024 bits and more are required. As each additional bit requires additional clusters, the number of clusters are already so high that creating the layout of each single cluster manually is ruled out for time reasons.

The complexity requirement is directly fulfilled by the most important property of the capacitance clusters: the high degree of information content of each single cluster. This information theoretical statement means, in simple words, that each cluster should contain a high degree of unknown information. In this instance it is the electrical capacitance. The less is known about the exact value, the more information it contains. It is this information that forms the basis of creating the private key with the described circuit realization. The information contained in the clusters represents the private key in “raw form”. If the electrical capacitance of all the clusters of a chip were known to outsiders with high accuracy the private key could be derived therefrom.

A randomly as possible structured buildup of the capacitance cluster is also necessary for the information content. Randomness ensures that no systematic “bias” is present, i.e. no preference of certain structures or patterns according to rules. Ideally the probability of a certain structure occurring is just as probable as a completely different structure occurring, i.e. the probability density is evenly distributed. This even distribution can, of course, vary within the limits set by the predetermined area, circuit use or process limitation—in short all the conditions that are known before hand. In mathematical terms, they reduce the search space of the possible structures and thus the information content of the cluster.

A third influencing value of the information content of the capacitance cluster is the relationship degree between two random clusters on a chip, i.e. the cross correlation. Minimal correlation means that nothing can be concluded from one cluster to the other, i.e. that no adversary is able to derive information about the capacitance of the other cluster from the knowledge of the capacitance of one cluster.

In the present example, the used algorithm is based on an iterative “trial-and-error” process, in which random lines and through contactings are placed which are then checked for violations of the design rules (DRC errors). If there is an error, the last change is reversed and another variant is tried.

The algorithm begins with creating the lines on a certain metal layer at a predetermined starting point. The flow diagram in FIG. 3 shows the functional course. The starting point and the start layer are required for connecting the capacitance cluster to the evaluation electronic which generates the bits for the key from the capacitance value of the cluster. The next step is at the beginning of each iteration of the algorithm: the random selection of suited parameters for creating a metal piece, including the width, length and orientation of the lines. Certain minimum widths and lengths as well as limitation to an angle of 45° are predetermined by the process. Ideally these process-based predeterminations (so-called design rules) are taken into consideration in the random selection of the parameters in order to minimize error probability in subsequently checking for compliance with the distance rule. This check for violation of the distance rule, called the design-rule check (DRC), is run after every new placement of a line piece. If there is a violation of a rule, the line is removed and another parameter combination is tested, the algorithm returns to parameter selection. If a metal piece (the line) has been placed without any errors, the end of the line is the beginning of the next metal piece. Correspondingly the starting point of the next line is set anew. These start and end points are simultaneously ideal positions at which a change in the metal layer is possible via through contacting (via) upward or downward. They are therefore entered into a special via list which is used in the creation of vias in a subroutine. This subroutine is called whenever a metal layer has been completely finished processing, regarding the target area, i.e. has been filled with line pieces of random size and orientation. The area is then considered filled when the maximum number of steps has been carried out, respectively the maximum number of metal pieces have been created. After creation of the vias, the current layer has at disposal one or a multiplicity of through contactings upward or downward. Thus one of these vias is a suited starting point for the next metal layer on which metal pieces are to be created anew in the same manner. For this reason, the new starting position is placed on the coordinates of one of the vias, for example the last created via. In the same manner the metal layer, to which the through contacting changes, is placed as the new starting layer. The number of metal layer changes can be controlled by providing a maximum value. It does not have to be the same as the number of available metal layers of the process, but rather should lie above it. In this manner it should be ensured that the metal-piece-generation algorithm returns to a layer on which metal pieces have already been created. This way it is prevented that the algorithm only creates structures which do not change orientation in vertical direction, i.e. similar to as a tower or a stack are built up. If the maximum number of layer changes is not yet reached, the algorithm returns to the beginning of the program flow to create anew metal pieces in the current layer. The algorithm ends when the maximum number has been reached.

FIG. 4 shows schematically the generation of through contactings. The routine is informed at the beginning of the current layer, the maximum number of vias to be created is set and the list of valid vias positions is transmitted. The subsequent steps are located inside a program loop which continues until the maximum number of created through contactings has been reached. First the first entry in the via list is removed from the list. The first entry is the position of the next via to be created. The via can then contact the next metal layer above or below. The latter is only possible if this layer is not the bottom metal layer, in which case a change is only possible upward. The same applies inversely for the top layer. For this reason the algorithm checks the current metal layer and decides whether the to-be-created via should be an upward or downward through contacting. If both directions are possible, one of the two possibilities is selected randomly with the same probability. Following this, the via is created and subjected to the distance check. If the change passes the test, the via is created according to the rule. If the maximum number of through contactings has not been reached, the algorithm jumps back to the beginning of the loop. Processing the next element of the via list begins, i.e. another via is created. If via creation did not comply with the rules, for example because the DRC check discovered a violation of the minimum distance between the via and an adjacent metal piece, the just created via is removed. The program flow then returns again to the beginning of the loop and processes the next position in the position list.

After generation of a cluster, its geometry is present in the form of a two-dimensional layout view in the layout editor. FIG. 5 shows such a view (here in black and white, the individual planes are distinguished by different colors in the editor). The cluster is stored as an independent design unit (cell) in a library and undergoes a capacitance analysis (extraction). For this purpose and for external further processing with tools of other EDA platforms, the layout is converted into a standard format (so-called GDSII or stream format).

A three-dimensional oblique view was created for the capacitance cluster generated with the layout of FIG. 5 in order to offer a better view of the structural buildup. On the other hand, a two-dimensional layout view, which is typical for all layout editors, shows little in the case of capacitance clusters, because it is intended for introducing geometric structures manually and is more advantageous with regular structures. The 3D view in FIG. 6 was created using a ray tracing program and a rendering program with which three dimensional scenes can be calculated taking into consideration light propagation, shading and reflection. In this manner, light and shading effects create an impression of depth conveying to the viewer the three-dimensionality of the viewed objects. In the left rear corner of the cluster in FIG. 6 is the connecting point for the evaluation electronic, a small, rectangular area on the top metal layer. In addition to the typical horizontal and vertical structures, some line pieces extend in oblique direction. The principle buildup is completely random and the single metal fragments are random in size and position. Finally, as a special feature small corners and bulges need to be mentioned. Primarily, it is the last three properties of the capacitance cluster which make it different from conventional, regular structures like those handmade by engineers or made by wiring tools (routers).

No local copies of the private key are required to use the present method. The method opens a very wide field of application and is a simple principle for imprinting and, if need be, generating a private key, which is firmly connected to a physical medium. The private key can be found only with great difficulty even if the method of generation is completely known.

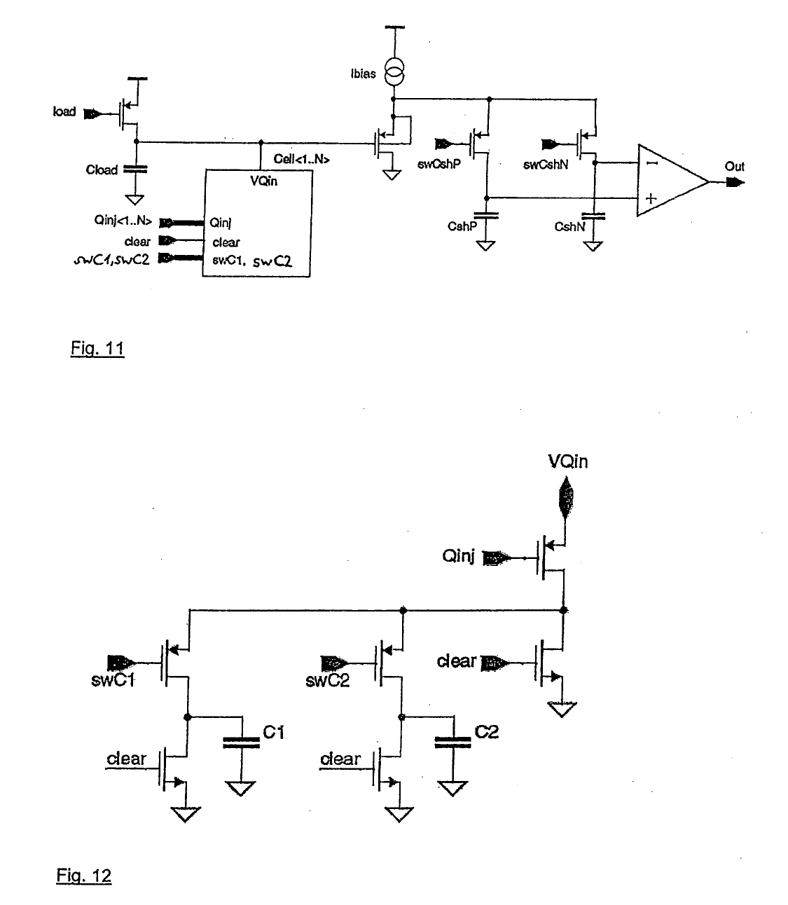

FIGS. 11 and 12 show another example of a measuring circuit for carrying out the invented method. This measuring circuit uses a technique based on a charge pump to compare the parasitic capacitances of two complex line structures. A very high degree of accuracy with little space requirements for the measuring circuit is achieved with this technique. The measuring circuit does not require any measuring devices and possesses a special provision which minimizes measuring errors stemming from the threshold value dispersion of the transistors used in the measuring circuit.

Charge-pump-based techniques of measuring small capacitances in integrated circuits are state of the art. In state-of-the-art methods the capacitance is determined from a linear fit using a number of measuring points. Each measuring point indicates the mean current at which a certain frequency and voltage is pumped into the to-be-measured capacitor. In charge pumps, two not overlapping clock pulses serve as switching signals for charging, respectively discharging, of the capacitor. The resulting mean current, which flows through the charging transistor into the capacitor in a predetermined interval, is measured with an external ammeter.

This method is modified in the present application in order to integrate the entire measuring circuit in an integrated circuit without external measuring devices. One such type measuring circuit is shown in FIG. 11, in which the cell with the to-be-compared capacitances is only indicated by the rectangle. One example of such a type cell is shown in detail in FIG. 12.

The mean current is not measured in the proposed measuring circuit. But rather a large capacitor C_{load} is integrated on the chip which is first precharged by a load signal “load” and then discharged step by step by a discharge signal Qᵢₙⱼ by pumping electrons into the just to-be-measured capacitance, for example C1 (see FIG. 12). In this manner, the starting voltage V_{Qin} diminishes with every clock pulse by an amount dependent on the to-be-measured capacitance C1 respectively C2. After a multiplicity of clock cycles, the voltage at the load capacitor C_{load} which is amplified by a PMOS source tracer, is sampled with a sample-and-hold element. This procedure is repeated with the second to-be-measured capacitance C2. Switching between the two capacitances C1, C2 occurs via the switching signals swC1 and swC2. Discharging of the respective capacitances C1, C2 is triggered by the “clear” signal. The voltages of the two capacitances C1, C2 sampled by the sample-and-hold element are compared in a comparator, which yields the bit value 0 or 1 dependent on the comparison. This procedure is repeated for all the cluster pairs, respectively line structures until the desired number of bits is read out. For this purpose, the cell in FIG. 11 can also contain more than two to-be-measured clusters. With two clusters, there is one possible comparative pair (1 bit), with three clusters 3 pairs (3 bit), with four clusters 6 pairs (6 bits) etc. Alternatively it is also possible to provide a separate measuring circuit for each cluster pair.

FIG. 12 shows an example of the cell with only one pair of capacitance clusters corresponding to the to-be-measured capacitances C1, C2. This figure also shows the aforementioned provision for minimizing measurement errors comprising the NMOS transistors allocated to the capacitances C1 respectively C2. The transistors are switched on by the signal “clear”.

Other types of transistors which fulfill the same switching functions can, of course, be employed in the measuring circuit in FIGS. 11 and 12 instead of PMOS and NMOS transistors.

The following examples show various different applications in which a chip or a chip card with a cryptographic key imprinted according to the present method can be employed.

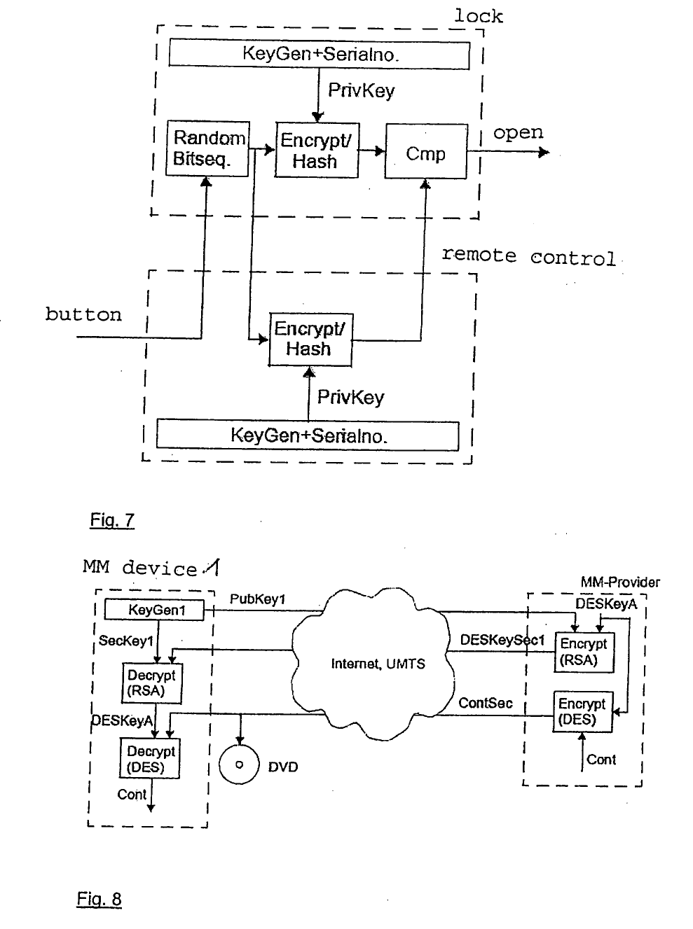

A first example of an application is a remote control electronic key for passenger cars (FIG. 7). The key generator (KeyGen), which uses the present method, generates the same private key (PrivKey) on all the chips. The private key is provided with a serial number in such a manner that for each pair comprising a lock and a remote control, there is an own private key which the lock and the remote control however share. This key then serves the purpose of encrypting the random bit sequence in the lock and in the remote control. This bit sequence is generated anew whenever the lock is locked or unlocked and exchanged between the lock and the remote control. Authorization is realized by comparing (Cmp) the encryption results in the remote control and in the lock: the encrypted bit sequence is exactly alike only if both, the lock and the remote control have the same key (PrivKey). Without knowledge of the private key, it is impossible for the adversary to replicate or copy the remote control in such a manner that it generates the same bit sequence as the lock or the original remote control.

Fundamentally, the present method or a chip obtained therewith can be used for any applications in which an authorization check, respectively access control should be realized (smart card applications). In this case as well, it is possible to proceed analogously to the aforementioned principle, i.e. the authenticity of the smart card can be checked by using an all-chips key.

Another application example relates to transmission and distribution of multimedia contents using a single-chip key. In the application instance, the aim is secure transmission and distribution of multi-media content, e.g. music or video flows. A device (mobile phone, walkman, computer, DVD player, etc.) should play multimedia content (Cont) which is to be obtained by a provider (MM provider) from the internet, for example on demand (On-Demand). The multimedia content should be playable infinitely often and security copies (e.g. on DVD) should be possible yet it should not be possible to use it with a third party's device.

The method shown in FIG. 8 permits such an application. Assuming that buyer A owns N multimedia devices for which he wants to buy the content. Each of these devices has its own public key, PubKey1 to PubKeyN, which are given to the multi-media provider upon purchase. The provider then generates (in a conventional manner) a new secret key (DESKeyA) per customer, which the provider encodes N times (i.e. for each of the customer's MM devices) with the keys PubKey1 to PubKeyN. The encrypted keys DESKeySec1 to DESKeySecN can then be decrypted by buyer A's multi-media devices but not by the devices of another person B. Due to this property, it is now possible to send the multimedia content via an open, not secured channel (internet, UMTS, etc.) if the content has been encrypted by the provider with buyer A's secret key DESKeyA. Buyer A'S devices are then able with the aid of the secret key DESKeyA to decrypt the multi-media content. As only these devices have disposal of their own secret key SecKey1 to SecKeyN no other person's device is able to gain access to Buyer A's key DESKeyA to decrypt its multi-media content.

In this application, too, it is useful to implement an authenticity check to ensure that all public keys stem from the multi-media device and were not created by the user himself. For this purpose an all-chips key (not depicted) can be used which is present in each MM device and available at all MM providers and is always the same. The MM device employs this key to encrypt the public keys PubKey1 to PubKeyN. Only when the MM device and the MM provider have the same key is it possible to exchange the keys PubKey1 to PubKeyN properly.

The problem of checking key authenticity discussed here is a fundamental problem with all public key methods. Presently, this problem is solved in that a public key is declared authentic only if it has been previously checked by a trusted institution. Usually, the key is then placed on a publicly accessible server. Analogously, in the described application case every public key of all MM devices could be read out at the manufacturer, published and in this manner verified before the devices are sold.

Another example relates to protecting software using the all-chips key and single-chip keys. The general term “software protection” refers to aspects which are also dealt with within the scope of the Trusted Computing Initiative. The primary concern is to execute software on a system only if it has been authorized. A presently applied form is product activation of a known operation system. The site of the private key assumes an individual number sequence which is derived from the hardware components of a computer using a secret method. This is solely for copy protection.

Such copy protection can also be realized with the single-chip key proposed in the present invention, however avoiding the following drawbacks:

1. Limited reproducibility.

Product activation has to be renewed each time if more than a certain number of hardware components of a computer change, respectively are replaced as the number sequence yielded by these components differs.

2. Implementation in poorly protected software.

The method for product activation, respectively comparison of a clear code and the number sequence of the hardware components is implemented in the operation system itself, i.e. occurs in the software. Reverse engineering (disassembly respectively debugging) permits deriving the used algorithm in order to calculate the respective clear code for the individual number sequence of the respective user. Knowledge of this algorithm allows anyone to generate a clear code for every hardware combination and to activate its operation system.

A list of similar cases can be continued. Whenever the concern is processing security-relevant information, it is necessary to protect the corresponding processing routines, i.e. to encrypt. The commands should be decrypted solely in the processor itself immediately before executing the commands. In all other parts of the computer, in particular on external data carriers, the sensitive parts of the program should be present solely in encrypted form.

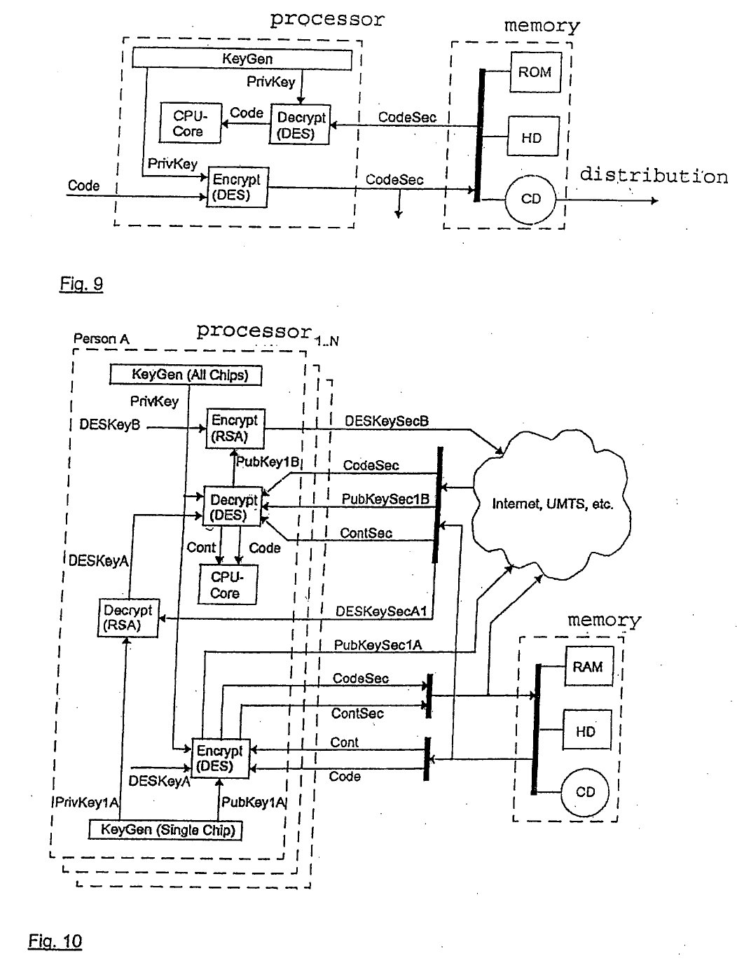

The diagram in FIG. 9 shows a corresponding solution approach. Each processor of a certain line of production (for all production lines) has the same private key PrivKey (all-chips key). With this key all the security critical commands (CodeSec) in the processor can be decrypted. Outside the processor, the command sequences are always encrypted. In order for a software producer to be able to encrypt his security-critical parts of the program, he activates the encryption unit (encrypt) and transmits to it the routines for encryption (code). The encrypted parts of the program are protected in this manner and can be distributed or sold (sales) together with the unprotected parts of the software. Activation of the encryption unit for its part can be realized by encrypted software routines in such a manner that, for example, an authorization check is included, which would ensure that not every user can encrypt large amounts of data arbitrarily often in order to calculate the private key from comparing the encrypted and not encrypted data (DES is considered very secure against this attack).

Regarding flexibility and security, the ideal case is the combination of the methods shown in FIGS. 8 and 9, i.e. use of an all-chips key and of single-chip keys. The latter characterize every processor in a distinct manner so that programs and, in particular, multi-media contents can only run on authorized processors. The all-chips key, on the other hand, ensures the authenticity of the processor (i.e. its single-chip keys) and permits keeping the software parts secret from the user and in this manner to protect against reverse engineering and manipulations.

FIG. 10 shows such an architecture schematically. Each of person A's N processors has its own, individual pair of keys PrivKeyXA and PubKeyXA, all other function processor units are identical. The key DESKeyB is person B's personal key with which multi-media contents but also security-critical program parts are encrypted for each of B's M processors. A generates it individually for B (in a conventional manner) and B encrypts it using the public keys PubKey1B . . . PubKeyMB. In order to ensure the authenticity of these keys, B encrypts them using the all-chips key PrivKey. In this manner they can only stem from the processors themselves and not from person A, B or someone else. In this way, people can exchange security-critical data without the recipient or an unauthorized third party being able to gain access to the unencrypted data. The encrypted data is, however, freely accessible so that copies of the data are protected, be they local copies in the main memory respectively on the hard disk or security copies.

Another application example is configuration in FPGAs. Programming, respectively, configurating some FPGAs is protected against viewing access in such a manner that the circuits realized in them are not accessible. The most important goal is to protect intellectual property on which the circuits are based against theft. Encrypting the configuration, based on an all-chips key and public key cryptography, could increase the security of the previous approaches. Programming a FPGA would be stored in the configuration memory only in encrypted form and would only be decrypted in the FPGA itself. As a way to save space, the RSA unit on the FPGA could comprise the programmable FPGA gates which are present anyway and are always used if the FPGA is to be reconfigured. Thus, they represent the reset configuration and are overwritten after successful decryption and programming with the new circuits. If the FPGA should be programmed anew, the gate configuration returns to the reset state in which the gates are switched to the RSA unit.

### LIST OF REFERENCE NUMERALS

1 current source

2-4 switches

5 parasitic capacitance

6 parasitic capacitance

7 comparator

8 output of the measuring circuit

9 electrical lines

10 through contacts

11 measuring circuit

What is claimed is:

1. A method for generating and imprinting a retrievable cryptographic key during the fabrication of a topographic structure, in particular for microelectronic or micromechanical components,
wherein a multiplicity of measuring circuits (11) is generated in the topographic structure, which measuring circuits each dependent on a value of at least one electrical or physical property in the topographic structure, which is subject to random fluctuations during the fabrication of the topographic structure containing the measuring circuits (11), generate a measuring value, and the cryptographic key is formed or derived from the measuring values of the measuring circuits (11),
wherein the measuring circuits (11) are composed of three-dimensional electrical line structures (9, 10), each of which is provided with a random design and is generated in the topographic structure, and generate the measuring values dependent on the values of a parasitic electrical property of the line structures (9, 10).

2. A method according to claim 1,
wherein the measuring circuits (11) generate the measuring values dependent on the value of a parasitic capacitance of the line structures (9, 10).

3. A method according to claim 1,
wherein each measuring circuit (11) is provided with two three-dimensional electrical line structures (9, 10) each of which is provided with a random design, identical for the individual measuring circuit (11), and is generated in the topographic structure,
and with a comparative unit (7), which compares the value of the parasitic electrical property of the two line structures (9, 10), with the measuring circuit (11) generating a bit value 0 or 1 dependent on the result of the comparison.

4. A method according to claim 3,
wherein the measuring circuits (11) generate the measuring values dependent on the value of a parasitic capacitance of the line structures (9, 10).

5. A method for imprinting a retrievable cryptographic key during the fabrication of a topographic structure, in particular for microelectronic or micromechanical components, wherein
the cryptographic key is provided in form of a bit sequence,
for each bit of the bit sequence a measuring circuit (11) is generated in the topographic structure, which circuit is provided with two three-dimensional electrical line structures (9, 10) and a comparison unit (7), which compares a value of a parasitic electrical property of the two line structures (9, 10), and
the measuring circuit (11) generates a bit value of 0 or 1 dependent on the result of the comparison,
wherein each of the two line structures (9, 10) is provided with a random design and is generated in the topographic structure and the random design of the two line structures (9, 10) of each measuring circuit (11) is selected so different or similar that the measuring circuit (11) generates the respective bit of the bit sequence.

6. A method according to claim 1 or claim 5,
wherein at first a great number of designs for the three-dimensional electrical line structures (9, 10) is created computer-aided and is introduced into a pool from which subsequently the suited designs for the production of the individual line structures (9, 10) of the measuring circuits (11) is selected.

7. A method according to one of the claims 1 to 5, p1 wherein creation of the designs occurs by means of an algorithm, which randomly selects the width, length and orientation of sections of the line structures (9, 10) in each plane of the line structures (9, 10) including connections (10) between different planes of the line structures (9, 10).

8. A method according to claim 1 or claim 5,
wherein production of the topographic structure containing the measuring circuits (11) occurs by means of a lithographic process.

9. A method according to claim 1 or claim 5, wherein
the measuring circuits (11) use a charge-pump-based technique for generating the measuring values dependent on the value of a parasitic capacitance of the line structures (9, 10).

10. A chip or a chip card having a topographic structure containing an imprinted cryptographic key according to the method of one of the claims 1 to 5 with the respective measuring circuits (11).
